(19) United States
(12) Patent Application Publication
(10) Pub. No.: US 2020/0117308 A1
(43) Pub. Date: Apr. 16, 2020

(54) ELECTRONIC DEVICE AND METHOD FOR DETERMINING TOUCH INPUT CONDITIONS BASED ON TYPE OF TOUCH INPUT

(71) Applicant: SAMSUNG ELECTRONICS CO., LTD., Suwon-si (KR)

(72) Inventors: Hoondo HEO, Suwon-si (KR); Aram SONG, Suwon-si (KR); Jungwon KIM, Suwon-si (KR); Hakyeol KIM, Suwon-si (KR)

(21) Appl. No.: 16/282,919

(22) Filed: Feb. 22, 2019

(30) Foreign Application Priority Data
Oct. 10, 2018 (KR) 10-2018-0120717

(51) Int. Cl. G06F 3/041; G06K 9/00

(52) U.S. Cl. CPC G06F 3/0416; G06K 9/00013; G06F 2203/04108; G06F 2203/04106; G06F 2203/04105

(57) ABSTRACT

Various embodiments of the disclosure relate to an electronic device for determining a touch input condition based on the type of touch input and an operating method thereof. The electronic device may include: a sensor module including a plurality of sensors; a touch circuit; a processor electrically connected to the sensor module and the touch circuit; and a memory electrically connected to the processor. The memory may include instructions that, when executed by the processor, control the electronic device to: receive information related to a touch input obtained by the touch circuit and/or by at least one of the plurality of sensors; identify the touch input type for the touch input based on the information related to the touch input; and determine a touch-related condition related to the touch circuit based on the identified touch input type.

### CROSS-REFERENCE TO RELATED APPLICATION

This application is based on and claims priority under 35 U.S.C. 119 to Korean Patent Application No. 10-2018-0120717, filed on Oct. 10, 2018, in the Korean Intellectual Property Office, the disclosure of which is incorporated herein by reference in its entirety.

### BACKGROUND

### 1. Field

The disclosure relates to an electronic device for performing operations in relation to touch input and an operating method in an electronic device.

### 2. Description of the Related Art

In recent years, electronic devices have been developed in various forms for the convenience of users.

The electronic device may receive user information through various types of input means for an input interface. These input means are being developed in various forms. The electronic device includes a touch screen in the form of an input/output device capable of performing input and display of information using a single screen.

The touch screen may be configured in various manners (e.g., resistive film (pressure-sensitive) type, optical (infrared) type, capacitive type, ultrasonic type, pressure type, etc.) depending on implementation principles and operating methods.

An electronic device may detect a touch input by a user on a touch circuit or a touch screen of a display. If the user is wearing gloves, or if a cover is provided on the touch screen, it is difficult to detect a touch input by the glove or the cover because the electronic device is set so as to effectively detect a touch input by the hand.

In order to identify the touch input even in the case of using the glove or the cover, it is necessary to further change the option setting by the user's manipulation. When the touch screen operates in the state of receiving the touch input via the glove or the cover according to the additional option setting, the touch screen may have a very high touch-sensitivity. Accordingly, when a touch by the hand is input, malfunction, such as a hover touch or the like, may occur.

### SUMMARY

According to various embodiments of the disclosure, it is possible to provide an electronic device for determining a touch input condition based on the type of touch input in order to perform a touch input operation without malfunction due a change in the touch input type for a touch input and to provide an operation method thereof.

According to various embodiments, an electronic device may include a sensor module including a plurality of sensors; a touch circuit, a processor electrically connected to the sensor module and the touch circuit; and a memory electrically connected to the processor. The memory may include instructions that, when executed by the processor, control the electronic device to receive information related to a touch input obtained by the touch circuit and/or by at least one of the plurality of sensors, to identify the touch input type for the touch input based on the information related to the touch input, and to determine a touch-related condition related to the touch circuit based on the identified touch input type.

In addition, according to various embodiments, an electronic device may include a touch circuit; a processor electrically connected to the touch circuit and a memory electrically connected to the processor, wherein the memory may include instructions that, when executed by the processor, control the electronic device to obtain a touch detection value for a touch input detected through the touch circuit, to obtain at least one of: a touch-sensitivity value and/or a touch-area value for the touch input using the touch detection value, to identify the touch input type for the touch input based on at least one of the obtained touch-sensitivity value and/or the obtained touch-area value, and to determine a touch-related condition related to the touch circuit based on the identified touch input type.

In addition, according to various embodiments, a non-transitory computer-readable recording medium may record a program to be executed in a computer, wherein the program may include executable instructions that, when executed by a processor, cause an electronic device to perform operations comprising: receiving information related to a touch input obtained by a touch circuit and/or by at least one of a plurality of sensors of an electronic device, identifying the touch input type for the touch input based on the information related to the touch input, and determining a touch-related condition related to the touch circuit based on the identified touch input type.

In addition, according to various embodiments, a non-transitory computer-readable recording medium may record a program to be executed in a computer, wherein the program may include executable instructions that, when executed by a processor, cause an electronic device to perform operations comprising: obtaining a touch detection value for a touch input detected through a touch circuit, obtaining at least one of a touch-sensitivity value and/or a touch-area value for the touch input using the touch detection value, identifying the touch input type for the touch input based on at least one of the obtained touch-sensitivity value and/or the obtained touch-area value, and determining a touch-related condition related to the touch circuit based on the identified touch input type.

In an electronic device and an operating method thereof according to various embodiments, the electronic device may identify the touch input type for a touch input based on information related to the touch input, and may determine a touch-related condition based on the identified touch input type, so that the sensitivity related to the touch can be automatically changed depending on the identified touch input type.

In addition, the electronic device does not need to separately change the option setting by the user's manipulation in order to change the touch sensitivity, and may identify the touch input without (or with reduced) malfunction even if the touch input type is changed.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an example electronic device in a network environment in which a touch input condition is determined based on the type of touch input according to various embodiments;

FIG. 2 is a block diagram illustrating an example display device that determines a touch input condition based on the type of touch input according to various embodiments;

FIG. 3 is a block diagram illustrating an example configuration of an electronic device according to embodiments;

FIGS. 4A and 4B are diagrams illustrating examples of the touch input types depending on a touch input in an electronic device according to various embodiments;

FIG. 5 is a chart illustrating an example of touch sensitivity of an electronic device according to various embodiments;

FIG. 6 is a flowchart illustrating an example operation of an electronic device according to various embodiments;

FIG. 7 is a flowchart illustrating an example operation of an electronic device according to various embodiments;

FIG. 8 is a flowchart illustrating an example operation of an electronic device according to various embodiments;

FIG. 9 is a flowchart illustrating an example operation of an electronic device according to various embodiments;

FIG. 10 is a flowchart illustrating an example operation of an electronic device according to various embodiments;

FIG. 11 is a flowchart illustrating an example operation of an electronic device according to various embodiments; and

FIG. 12 is a flowchart illustrating an example operation of an electronic device according to various embodiments.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

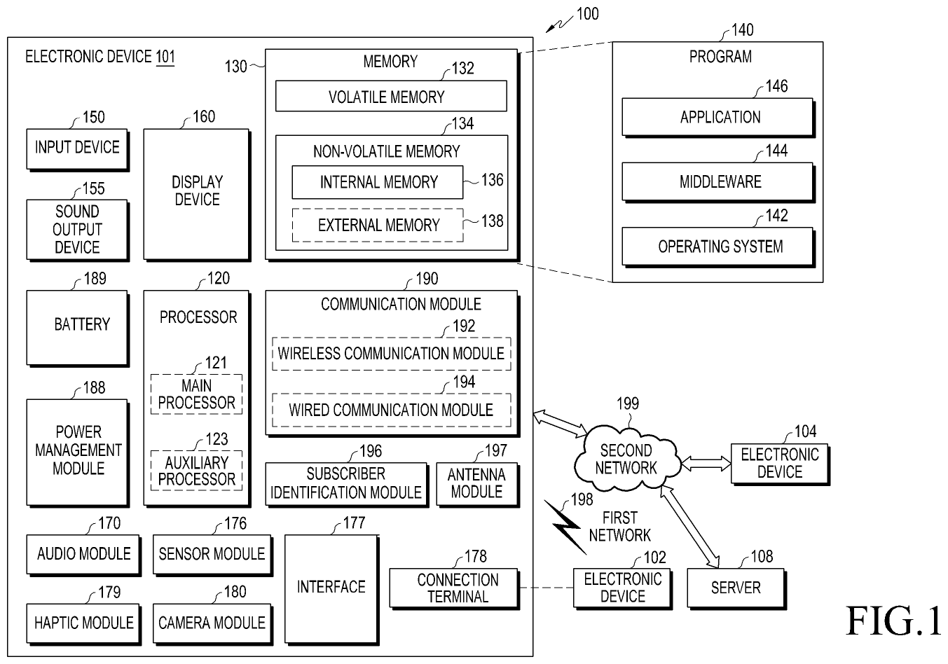

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added. FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

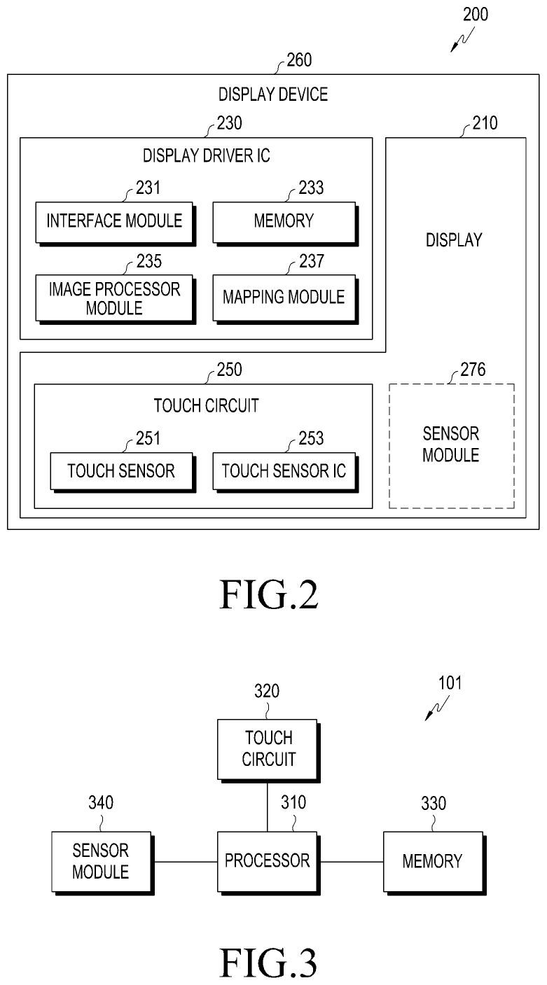

FIG. 2 is a block diagram 200 illustrating the display device 160 according to various embodiments. Referring to FIG. 2, the display device 160 may include a display 210 and a display driver integrated circuit (DDI) 230 to control the display 210. The DDI 230 may include an interface module 231, memory 233 (e.g., buffer memory), an image processing module 235, or a mapping module 237. The DDI 230 may receive image information that contains image data or an image control signal corresponding to a command to control the image data from another component of the electronic device 101 via the interface module 231. For example, according to an embodiment, the image information may be received from the processor 220 (e.g., the main processor 121 (e.g., an application processor)) or the auxiliary processor 123 (e.g., a graphics processing unit) operated independently from the function of the main processor 121. The DDI 230 may communicate, for example, with touch circuitry 150 or the sensor module 276 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 210 may be driven, for example, based at least in part on the voltage value or the current value such that visual information (e.g., a text, an image, or an icon) corresponding to the image data may be displayed via the display 210.

According to an embodiment, the display device 160 may further include the touch circuitry 250. The touch circuitry 250 may include a touch sensor 251 and a touch sensor IC 253 to control the touch sensor 251. The touch sensor IC 253 may control the touch sensor 251 to sense a touch input or a hovering input with respect to a certain position on the display 210. To achieve this, for example, the touch sensor 251 may detect (e.g., measure) a change in a signal (e.g., a voltage, a quantity of light, a resistance, or a quantity of one or more electric charges) corresponding to the certain position on the display 210. The touch circuitry 250 may provide input information (e.g., a position, an area, a pressure, or a time) indicative of the touch input or the hovering input detected via the touch sensor 251 to the processor 220. According to an embodiment, at least part (e.g., the touch sensor IC 253) of the touch circuitry 250 may be formed as part of the display 210 or the DDI 230, or as part of another component (e.g., the auxiliary processor 123) disposed outside the display device 160.

According to an embodiment, the display device 160 may further include at least one sensor (e.g., a fingerprint sensor, an iris sensor, a pressure sensor, or an illuminance sensor) of the sensor module 276 or a control circuit for the at least one sensor. In such a case, the at least one sensor or the control circuit for the at least one sensor may be embedded in one portion of a component (e.g., the display 210, the DDI 230, or the touch circuitry 250)) of the display device 160. For example, when the sensor module 276 embedded in the display device 160 includes a biometric sensor (e.g., a fingerprint sensor), the biometric sensor may obtain biometric information (e.g., a fingerprint image) corresponding to a touch input received via a portion of the display 210. As another example, when the sensor module 276 embedded in the display device 160 includes a pressure sensor, the pressure sensor may obtain pressure information corresponding to a touch input received via a partial or whole area of the display 210. According to an embodiment, the touch sensor 251 or the sensor module 276 may be disposed between pixels in a pixel layer of the display 210, or over or under the pixel layer.

In various embodiments of the disclosure as described below, an input means for a touch input made on a touch screen of a touch circuitry or display (e.g., the display 210 of FIG. 2) may be described as the touch input type. The touch input type may be divided into a touch by a hand, a touch by a gloved hand or a touch on a cover attached to a display device (e.g., 160 of FIGS. 1 and 2), a touch by an electronic pen, and the like. In addition, the touch type may be divided into various types according to touches by various input means. In the following description of the various embodiments of the disclosure made with reference to the accompanying drawings, a touch by a hand will be referred to as a first touch input type, and a touch by a glove or cover will be referred to as a second touch input type.

Hereinafter, an electronic device according to various embodiments will be described with reference to the accompanying drawings.

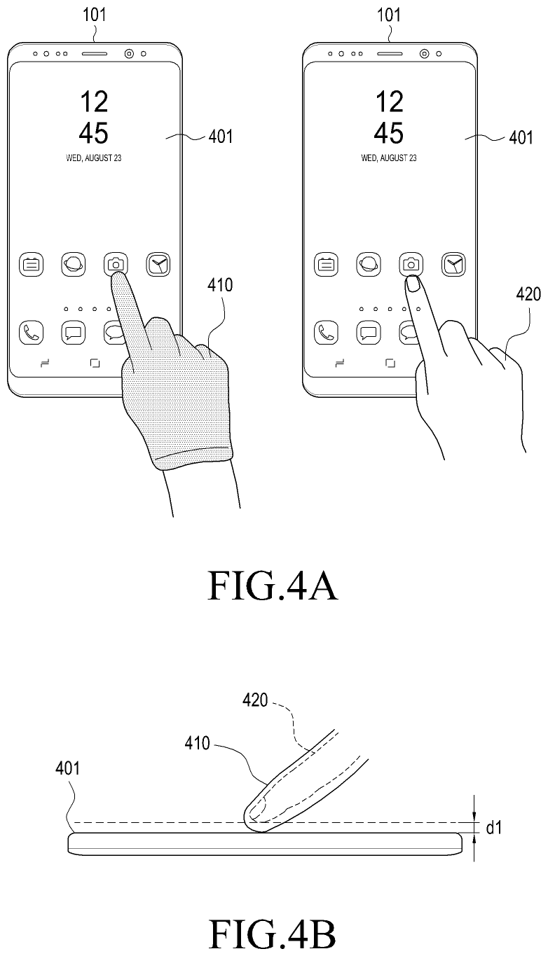

FIG. 3 is a block diagram illustrating an example configuration of an electronic device according to various embodiments. FIGS. 4A and 4B are diagrams illustrating examples of the touch input types depending on a touch input in an electronic device according to various embodiments.

Referring to FIG. 3, the electronic device 101 according to various embodiments may include a processor (e.g., including processing circuitry) 310, a touch circuit 320, a memory 330, and a sensor module (e.g., including sensing circuitry and/or at least one sensor) 340.

According to various embodiments, the processor 310 may be electrically connected to the touch circuit 320, the memory 330, and the sensor module 340 to identify the touch input type for a touch input, thereby changing a touch-related condition according to the identified touch input type. The touch input types, for example, may be classified into a first touch input type indicating a touch by a glove (or a cover) 410 as shown in FIGS. 4A and 4B and a second touch input type indicating a touch by the hand 420 as shown in FIGS. 4A and 4B.

According to various embodiments, the processor 310 may include various processing circuitry and obtain information related to a touch input using at least one of a plurality of sensors included in the sensor module 340. When a touch input by the user occurs according to various embodiments, the processor 310 may receive a touch detection value (e.g., at least one of a voltage value, a light-amount value, a resistance value, a charge-amount value, a position value (coordinates or distance between touch points), a touch-area value, a time value, or a force (or pressure) value) detected by at least one of various sensors included in the touch circuit 320 or various sensors disposed at positions corresponding to a touch screen area of a display (e.g., the display 210 in FIG. 2), thereby identifying the occurrence of the touch input. According to various embodiments, for example, the time value, among the touch detection values, may be used to identify the touch sensitivity. The distance between touch points may be used, for example, to initialize the time or to identify the touch input type for the touch input only if the touch of a specific sensitivity moves over a certain distance. According to various embodiments, if the movement of a touch is not identified at a certain touch point, the processor 310 may confirm that the distance between touch points is 0 or less than a predetermined value, and since it may not be recognized as a touch with user's intention, the processor 310 may not perform an operation of identifying the touch input type for the touch input. According to various embodiments, the processor 310 may obtain at least one of the touch sensitivity, the touch area, and a force value as information related to the touch input using the touch detection value. The information related to the touch input may include at least one of a touch-sensitivity value, a touch-area value, a force value, and fingerprint input information, and may further include a variety of information in relation to the touch input in addition thereto. According to various embodiments, the processor 310 may obtain fingerprint input information using a fingerprint sensor included in the touch circuit 320, a fingerprint sensor disposed at a position corresponding to the touch screen area of the display 210, or a fingerprint sensor disposed at a separate position (e.g., home button area). For example, the processor 310 may obtain fingerprint input information, which was detected by a fingerprint sensor disposed at a separate position and stored in the memory 320, when the screen is unlocked or user authentication is performed prior to the touch input.

According to various embodiments, the processor 310 may identify the touch input type (e.g., a touch 410 by the glove or cover in FIGS. 4A and 4B or a touch 420 by the hand in FIGS. 4A and 4B) for a touch input based on the information related to the touch input (e.g., at least one of a touch-sensitivity value, a touch-area value, a force value, or fingerprint input information), and may determine a touch-related condition in relation to the touch circuit 320 according to the identified touch input type. The processor 310 may automatically change the touch-related condition without a user's manipulation to change the touch-related condition. The touch-related condition may be a condition related to the sensitivity indicating the ability for a response to a touch associated with the touch circuit 320 or a touch on the touch screen (e.g., the touch screen 401 in FIGS. 4A and 4B), and may include at least one of the touch sensitivity, the touch area, and a hover rejection condition. The hover rejection condition may indicate a hover rejection rate calculated based on a specified minimum touch-sensitivity value and a specified touch-area value.

According to various embodiments, the processor 310 may preset a touch-related condition (e.g., first touch-related condition) in order to identify a touch input by the glove (or cover) 410 as shown in FIG. 4A, and may set the touch circuit 320 or the touch screen 401 as the operation state in which the touch input of the glove (or cover) can be detected based on the specified touch-related condition.

According to various embodiments, the processor 310 may be configured to perform an operation for touch recognition differently depending on the sensitivity of the touch screen (that is, depending on the touch-related condition). For example, as shown in FIG. 4B, when the user applies a touch input to the touch screen 401 with a gloved hand, a touch detection value may be less than the touch detection value for the touch input by the hand 420 because there is the difference dl in distance between the hand 420 and the glove 410 on the touch screen 401. If a touch input by the glove 410 is received under the condition for the touch input by the hand, the processor 310 may fail to detect the touch input by the glove 410. Thus, the processor 310 may perform control so as to identify the touch input according to the touch-related conditions, which are set differently depending on the touch input type. According to various embodiments, the processor 310 may perform control such that the touch screen 401 operates in a first operation in which the type of touch input by a glove or a cover can be identified. The processor 310 may perform control such that the touch screen 401 operates in a second operation in which the type of touch input by the hand can be identified.

According to various embodiments, if the identified touch input type is a first touch input type (e.g., a touch by the glove or cover), and if the touch screen operates in the first operation, the processor 310 may perform control so as to maintain the first operation. If the touch input corresponds a second touch input type (e.g., a touch by the hand), the processor 310 may change the touch-related condition into a condition corresponding to the second operation so that the touch screen operates in the second operation. In addition, the touch-related condition may be set or changed differently according to other touch input types.

According to various embodiments, the touch-related condition corresponding to the first touch input type (e.g., a touch by the glove or cover), which is a first touch-related condition, may include at least one of a first touch-sensitivity reference value configured so as to detect even a small touch detection value, a first touch-area reference value configured so as to detect even a large touch area, or a first hover rejection condition configured so as to seldom allow the hover rejection. According to various embodiments, the touch-related condition corresponding to the second touch input type (e.g., a touch by the hand), which is a second touch-related condition, may include at least one of a second touch-sensitivity reference value configured so as to reject a small touch detection value or a small touch-sensitivity value, a second touch-area reference value configured to have a touch area smaller than that of the first touch-area reference value, or a second hover rejection condition configured so as to easily allow the hover rejection.

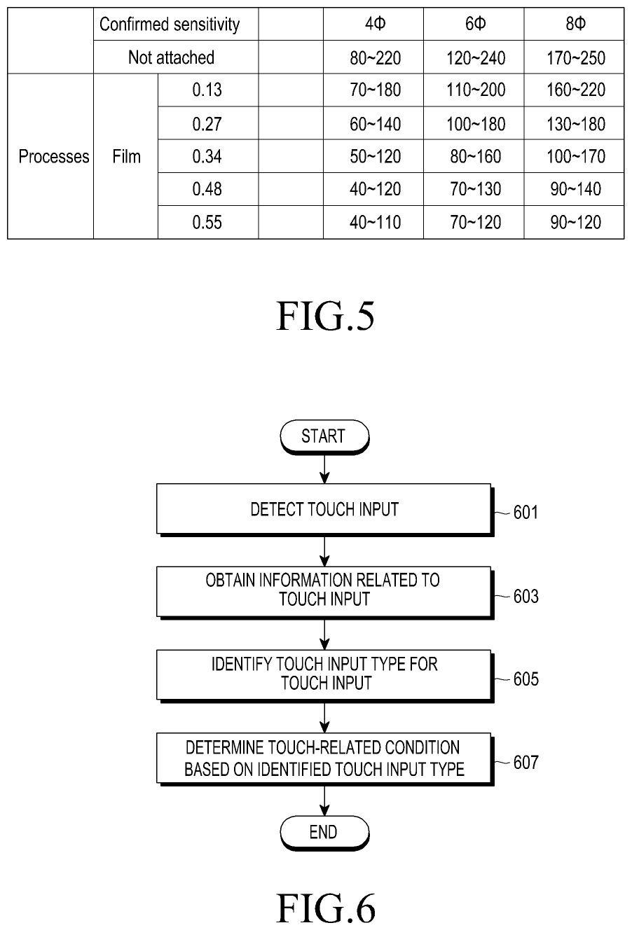

FIG. 5 is a chart illustrating an example of the touch-sensitivity value obtained for a touch input detected depending on the thickness of a film in the case where a cover (e.g., a film) is provided on the touch screen of a display of an electronic device. According to various embodiments, the processor 310, for example, may set a touch-sensitivity reference value based on the sensitivity values (or the sensitivity value range) obtained as shown in FIG. 5, and may set a touch-related condition based on the same. For example, referring to FIG. 5, it can be seen that the minimum sensitivity value with respect to the same touch area is 80 when a film is not attached to the touch screen, which is double the minimum sensitivity value of 40 when a film having a thickness of 0.48T or 0.55T subject to a high-sensitivity condition is attached to the touch screen. When the second touch input type is identified, the processor 310 may set the second touch-sensitivity reference value as high as, for example, double (200%+/−20%) the first touch-sensitivity reference value, may set the second touch-area reference value as low as, for example, 70%+/−30% of the first touch-area reference value, and may set the hover rejection condition using the minimum touch-sensitivity value and the obtained touch-area value.

The above-described FIG. 5 shows only an example for convenience of explanation according to various embodiments, and other touch-sensitivity values may be obtained depending on the processing conditions and the thickness of the glove or cover.

According to various embodiments, when the touch input is identified as the first touch input type, the processor 310 may identify the second touch input in the maintained touch-related condition (e.g., the first touch-related condition). When the touch input is identified as the second touch input type, the processor 310 may identify the second touch input in the changed touch-related condition (e.g., the second touch-related condition).

Various embodiments above have described that the current touch-related condition is changed into the second touch-related condition if the second touch input type (e.g., a touch by the hand) is identified in the current first operation. Similarly, if the first touch input type (e.g., a touch by the glove or cover) is identified in the second operation, it is possible to identify the touch input type as described above, thereby automatically changing the touch-related condition to the first touch-related condition according to the identified touch input type.

According to various embodiments, the processor 310 may obtain at least one of the touch sensitivity and the touch area as information related to the touch input based on the touch detection value (e.g., at least one of a voltage value, a light-amount value, a resistance value, a charge-amount value, a position value (coordinates), a touch-area value, or a force (or pressure) value) detected by the touch screen or a plurality of sensors for the touch input. According to various embodiments, the processor 310 may compare the touch detection value (e.g., at least one of a resistance value, a current value, or a force (or pressure) value) with a specified touch detection reference value in order to identify the touch input type for the touch input. According to various embodiments, the touch-sensitivity value and the touch-area value may be obtained using the touch detection value. According to various embodiments, the processor 310 may identify the touch input as the first touch input type (e.g., a touch by the glove or cover) if the touch-sensitivity value is less than a specified first touch-sensitivity reference value, and may identify the touch input as the second touch input type (e.g., a touch by the hand) if the touch-sensitivity value is not less than the specified first touch-sensitivity reference value. According to various embodiments, the processor 310 may identify the touch input as the first touch input type (e.g., a touch by the glove or cover) if the touch-area value is greater than a specified first touch-area reference value, and may identify the touch input as the second touch input type (e.g., a touch by the hand) if the touch-area value is not greater than the specified first touch-area reference value.

According to various embodiments, the processor 310 may obtain fingerprint input information detected by at least one (e.g., a fingerprint sensor) of a plurality of sensors for the touch input as information related to touch input. According to various embodiments, the processor 310 may identify the second touch input type as a touch input by the hand if the fingerprint input information is obtained, and may identify the first touch input type if the fingerprint input information is not obtained.

According to various embodiments, the processor 310 may confirm the touch-sensitivity value and/or the touch-area value, and may further confirm the fingerprint input information, thereby identifying the touch input type more accurately.

According to various embodiments, the processor 310 may obtain a force value using at least one (e.g., a pressure sensor) of the plurality of sensors. According to various embodiments, the processor 310 may identify the touch input as the first touch input type if the obtained force value is greater than a specified force reference value, and may identify the touch input as the second touch input type if the force value is not greater than the specified force reference value.

According to various embodiments, the processor 310 may confirm the touch-sensitivity value and/or the touch-area value, and may further confirm the force value, thereby identifying the touch input type more accurately.

According to various embodiments, the processor 310 may more accurately identify the touch input type by confirming the fingerprint input information and the force value. According to various embodiments, the processor 310 may identify the touch input type by means of various combinations of the sequences of the operations of confirming the touch sensitivity, the touch area, the fingerprint information, or the force.

According to various embodiments, the processor 310 may confirm at least one of the touch-sensitivity value or the touch-area value and both the fingerprint input information and the force value, thereby identifying the touch input type more accurately.

The processor 310, may, for example, be a hardware module and/or a software module (e.g., an application program), may be a hardware element (function) including at least one of various sensors, data measurement modules, input/output interfaces, modules for managing the state or environment of the electronic device 101, communication modules, or the like, which are provided in the electronic device 101, or may be a software element (program). According to various embodiments, the processor 310 may include, for example, hardware, software, firmware, or any combination thereof. In addition, according to various embodiments, the processor 310 may be configured to exclude at least some of the elements above, or may be configured to further include other elements for performing an image-processing operation in addition thereto.

The touch circuit 320 (e.g., the same as or similar to the display device 160 in FIG. 1, the display device 260 in FIG. 2, or the display 210 in FIG. 2) of the electronic device 101 according to various embodiments is an input interface capable of detecting a touch according to a touching operation by the user. According to various embodiments, the touch circuit 320 of the electronic device 101 may include a display that can be implemented as a touch screen (e.g., touch screen 401 in FIGS. 4A and 4B), and the touch screen is an input interface capable of displaying a variety of information generated according to a touching operation by the user. The touch screen may output operation execution result information (e.g., at least one of text, images, or videos) under the control of the processor 310. According to various embodiments, the display may display an input pad (for example, buttons), in which at least one of various characters, numbers, or symbols may be input into the input window, on the screen in various manners. In addition, the display may display service execution screens according to execution of various applications related to transmission/reception of information.

According to various embodiments, the display of the second electronic device 101 may include, for example, and without limitation, at least one of a liquid crystal display (LCD), a thin-film transistor LCD (TFT-LCD), an organic light-emitting diode (OLED), a light-emitting diode (LED), an active matrix organic LED (AMOLED), a flexible display, a three-dimensional display, or the like. Some of the above displays may be configured to be transparent or light-transmissive so that the outside can be viewed therethrough. These displays may be configured as transparent displays including a transparent OLED (TOLED). According to various embodiments, the electronic device 101 may further include another display (e.g., an extension display or a flexible display) provided in addition to the above display or a display of another electronic device outside the electronic device 101 (e.g., at least one of an external display device, a wearable device, or an external terminal device), which is associated with the electronic device 101.

According to various embodiments, the memory 330 (e.g., the memory 130 in FIG. 1) may store a variety of data generated during the execution of the programs 140, as well as programs (e.g., the programs 140 in FIG. 1) necessary for the functional operation according to various embodiments. The memory 330 may include a program area 140 and a data area (not shown). The program area 140 may store information on programs for driving the second electronic device 101, such as an operating system (OS) (e.g., the operating system 142 of FIG. 1) for booting of the second electronic device 101. The data area (not shown) may store transmitted and/or received data and generated data according to various embodiments. In addition, the memory 330 may be configured to include at least one of storage media, such as a flash memory, a hard disk, a multimedia card micro type memory (e.g., a secure digital (SD) or extreme digital (XD) memory), a RAM, and a ROM.

According to various embodiments, the memory 330 may store touch-related conditions specified to identify the touch input on the touch circuit 320, touch detection values detected by a plurality of sensors, and touch input-related information (e.g., at least one of a touch-sensitivity value, a touch-area value, or a force value) obtained using the touch detection values. The memory 330 may store fingerprint input information detected by at least one (e.g., a fingerprint sensor) of the plurality of sensors. The memory 330 may include information related to an operation of identifying the touch input type, an operation of determining a touch-related condition according to the identified touch input type, and an operation of identifying the touch input according to the determined touch-related condition.

According to various embodiments, the sensor module 340 (the same as or similar to the sensor module 176 in FIG. 1 or the sensor module 276 in FIG. 2) of the electronic device 101 may include various sensing circuitry and/or types of sensors, and may be electrically connected to the processor 310, thereby transmitting a signal detected by at least one of the plurality of sensors to the processor 310. The sensor module 340 may include at least one sensor (e.g., a touch sensor, a pressure sensor, a fingerprint sensor, or an optical sensor) for detecting a touch input by means of the touch circuit 320. The sensor module 340 may include at least one sensor (e.g., a fingerprint sensor) for obtaining fingerprint input information in the area (e.g., a home button area) other than the area corresponding to the touch screen area of the electronic device.

As described above, the elements of the electronic device 101 have been described through the electronic device 101 in FIG. 3 in the various embodiments. However, in the various embodiments, not all the elements illustrated in FIG. 3 are essential elements, and the electronic device 101 may be implemented by more or fewer elements than the illustrated elements. In addition, the positions of the elements of the electronic device 101 described above with reference to FIG. 3 may vary with various embodiments.

An electronic device (e.g., the electronic device 101) according to any one of various embodiments may include a sensor module including a plurality of sensors; a touch circuit, a processor electrically connected to the sensor module and the touch circuit; and a memory electrically connected to the processor. The memory may include instructions that, when executed by the processor, control the electronic device to: receive information related to a touch input obtained by the touch circuit and/or by at least one of the plurality of sensors, identify the touch input type for the touch input based on the information related to the touch input, and determine a touch-related condition related to the touch circuit based on the identified touch input type.

According to various embodiments, the information related to the touch input may be obtained using a touch detection value for the touch input, and may include at least one of a touch-sensitivity value, a touch-area value, a force value, and/or fingerprint input information, and the touch-related condition may include at least one of a touch sensitivity condition, a touch area condition, and/or a hover rejection condition.

According to various embodiments, the instructions may, when executed by the processor, control the electronic device to identify a first touch input type for the touch input if a touch-sensitivity value included in the information related to the touch input is less than a specified touch-sensitivity reference value and/or if a touch-area value included in the information related to the touch input is greater than a specified touch-area reference value, and maintain the touch-related condition corresponding to the identified first touch input type.

According to various embodiments, the instructions may, when executed by the processor, control the electronic device to identify a second touch input type for the touch input if a touch-sensitivity value included in the information related to the touch input is not less than a specified touch-sensitivity reference value and/or if a touch-area value included in the information related to the touch input is not greater than a specified touch-area reference value, and change the touch-related condition into a touch-related condition corresponding to the identified second touch input type.

According to various embodiments, the instructions may, when executed by the processor, control the electronic device to identify a first touch input type for the touch input if a touch-sensitivity value included in the information related to the touch input is less than a specified touch-sensitivity reference value and/or if a touch-area value included in the information related to the touch input is greater than a specified touch-area reference value, and maintain the touch-related condition corresponding to the identified first touch input type.

According to various embodiments, the instructions may, when executed by the processor, control the electronic device to identify a second touch input type for the touch input if a touch-sensitivity value included in the information related to the touch input is not less than a specified touch-sensitivity reference value and/or if a touch-area value included in the information related to the touch input is not greater than a specified touch-area reference value, and change the touch-related condition into a touch-related condition corresponding to the identified second touch input type.

According to various embodiments, the instructions may, when executed by the processor, control the electronic device to identify a first touch input type for the touch input if fingerprint input information included in the information related to the touch input is not confirmed; maintain the touch-related condition corresponding to the identified first touch input type, and identify a second touch input type for the touch input if fingerprint input information included in the information related to the touch input is confirmed.

According to various embodiments, the instructions may, when executed by the processor, control the electronic device to, identify a first touch input type for the touch input if a force value included in the information related to the touch input is not greater than a specified force reference value and maintain the touch-related condition corresponding to the identified first touch input type, and identify a second touch input type for the touch input if a force value included in the information related to the touch input is greater than a specified force reference value and change the touch-related condition into a touch-related condition corresponding to the identified second touch input type.

According to various embodiments, the instructions may, when executed by the processor, control the electronic device to identify a first touch input type for the touch input if fingerprint input information included in the information related to the touch input is not confirmed and if a force value included in the information related to the touch input is not greater than a specified force reference value and maintain the touch-related condition corresponding to the identified first touch input type, and identify a second touch input type for the touch input if fingerprint input information included in the information related to the touch input is confirmed and if a force value included in the information related to the touch input is greater than a specified force reference value and change the touch-related condition into a touch-related condition corresponding to the identified second touch input type.

According to various embodiments, the instructions may, when executed by the processor, control the electronic device to: identify a second touch input type for the touch input if the touch-sensitivity value and the touch-area value included in the information related to the touch input are not confirmed and if fingerprint input information is confirmed; and change the touch-related condition into a touch-related condition corresponding to the identified second touch input type.

According to various embodiments, the changed touch-related condition may include at least one of a second touch-sensitivity reference value set to be greater than the specified first touch-sensitivity reference value, a second touch-area reference value set to be less than the specified first touch-area reference value, and a hover reject condition in which the hover rejection rate is set to be high.

Example operations of the above-described electronic device will be described in greater detail below with reference to the accompanying drawings.

FIG. 6 is a flowchart illustrating an example operation of an electronic device according to various embodiments.

Referring to FIG. 6, when a touch input by the user occurs, the electronic device (e.g., the electronic device 101 in FIG. 1, 2, or 3) according to various embodiments may detect the touch input using at least one of a plurality of sensors included in the sensor module (e.g., the sensor module 276 in FIG. 2 or the sensor module 340 in FIG. 3) or the touch screen (e.g., the touch circuit 320 in FIG. 3) in operation 601. According to various embodiments, the electronic device may obtain a touch detection value (e.g., at least one of a voltage value, a light-amount value, a resistance value, a charge-amount value, a position value (coordinates), a touch-area value, or a force (or pressure) value) detected by the touch screen or by at least one of the plurality of sensors. According to various embodiments, the electronic device may obtain fingerprint input information detected by at least one (e.g., a fingerprint sensor) of the plurality of sensors as information related to the touch input. According to various embodiments, the electronic device may obtain fingerprint input information detected by a fingerprint sensor when the touch input occurs. According to various embodiments, the electronic device may obtain fingerprint input information, which was detected by a fingerprint sensor disposed at a separate position and stored in the memory 320, when the screen is unlocked or user authentication is performed prior to the touch input.

In operation 603, the electronic device may obtain information related to the touch input using the touch detection value. The information related to the touch input may include at least one of a touch-sensitivity value, a touch-area value, a force value, or fingerprint input information.

In operation 605, the electronic device may identify the touch input type (e.g., a touch by the hand or a touch by the glove or cover) for the touch input based on the information related to the touch input (e.g., at least one of the touch sensitivity, the touch area, the force value, or the fingerprint input information).

In operation 607, the electronic device may determine a touch-related condition specified based on the identified touch input type. The touch-related condition may be a condition related to the sensitivity indicating the ability for a response to a touch on the touch circuit 320, and may include at least one of the touch sensitivity, the touch area, and the hover rejection. According to various embodiments, the electronic device may perform an operation of identifying the touch input differently depending on the sensitivity of the touch screen (that is, depending on the touch-related condition).

According to various embodiments, the electronic device may perform control to maintain a first operation if the identified touch input type is a first touch input type (e.g., a touch by the glove or cover) and if the touch screen currently operates in the first operation. If the identified touch input type is a second touch input type (e.g., a touch by the hand), the electronic device may change the touch-related condition into a condition corresponding to a second operation so that the touch screen operates in the second operation.

The operation procedure in FIG. 6 may be repeatedly performed each time a touch input is detected and/or when a touch input is detected after a specified time.

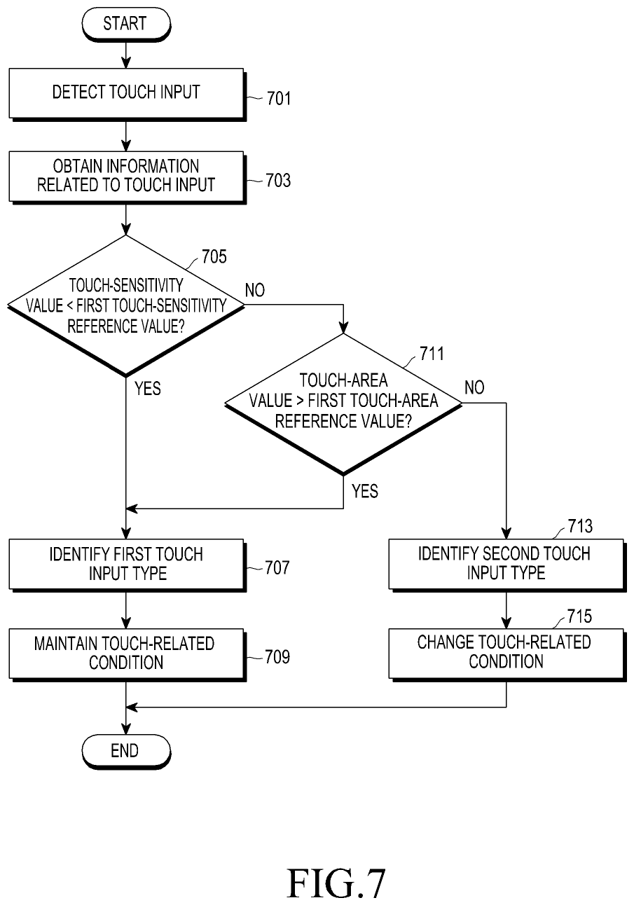

FIG. 7 is a flowchart illustrating an example operation of an electronic device according to various embodiments.

In operation 701, the electronic device may detect a touch input by at least one of a plurality of sensors included in the sensor module (e.g., the sensor module 276 in FIG. 2 or the sensor module 340 in FIG. 3).

As the electronic device detects the touch input, the electronic device may obtain a touch detection value from the at least one sensor, and may obtain information related to the touch input using the obtained touch detection value in operation 703. The information related to the touch input may include at least one of a touch-sensitivity value or a touch area, which is obtained using the touch detection value.

In operation 705, the electronic device may compare the touch-sensitivity value included in the obtained information related to the touch input with a specified first touch-sensitivity reference value. As a result of the comparison, if the touch-sensitivity value is less than the first touch-sensitivity reference value, the electronic device may perform operation 707.

In operation 707, the electronic device may identify the touch input type for the touch input as a first touch input type (e.g., a touch by the glove or cover). In operation 709, the electronic device may maintain the touch-related condition specified for the first touch input type.

If the touch-sensitivity value is not less than the first touch-sensitivity reference value as a result of the comparison in operation 705, the electronic device may compare a touch-area value with a first touch-area reference value included in the specified touch-related condition in operation 711. As a result of the comparison, if the touch-area value is greater than the first touch-area reference value, the electronic device may perform operation 707 and operation 709.

If the touch-area value is not greater than the first touch-area reference value as a result of the comparison in operation 711, the electronic device may identify the touch input type for the touch input as a second touch input type (e.g., a touch by the hand) in operation 713. In operation 715, the electronic device may change the specified touch-related condition into a touch input condition for easily identifying a touch input of the second touch input type. That is, the electronic device may switch from the first touch-related condition specified to correspond to the first touch input type to the second touch-related condition corresponding to the second touch input type.

According to various embodiments, the electronic device may perform only one of the comparison of the touch-sensitivity value in operation 705 or the comparison of the touch-area value in operation 711, among the operations in FIG. 7 described above, thereby identifying the touch input type for the touch input.

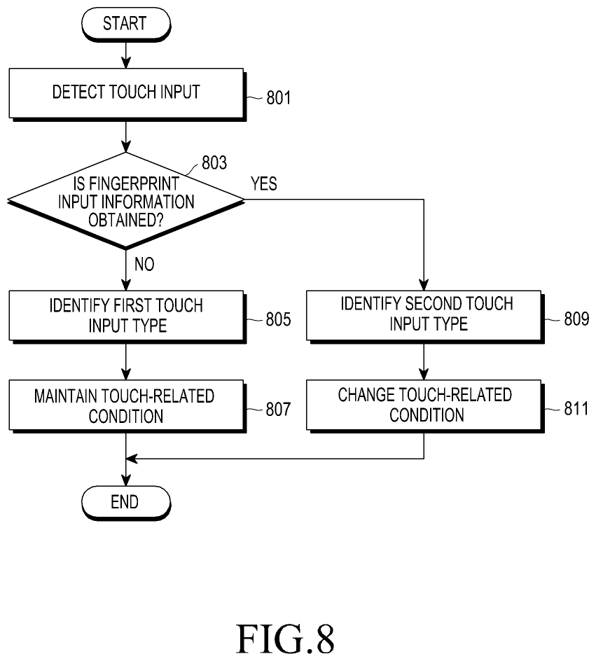

FIG. 8 is a flowchart illustrating an example operation of an electronic device according to various embodiments.

In operation 801, when a touch input by the user occurs, the electronic device may detect the touch input using at least one (e.g., a fingerprint sensor) of a plurality of sensors included in the sensor module (e.g., the sensor module 276 in FIG. 2 or the sensor module 340 in FIG. 3).

In operation 803, the electronic device may confirm whether fingerprint input information related to the touch input has been obtained. If the fingerprint input information has not been obtained as a result of the confirmation, the electronic device may identify the touch input type for the touch input as a first touch input type in operation 805. In operation 807, the electronic device may maintain the touch-related condition specified for the first touch input type.

If the fingerprint input information is confirmed as a result of the confirmation in operation 803, the electronic device may identify the touch input type for the touch input as a second touch input type (e.g., a touch by the hand) in operation 809. In operation 811, the electronic device may change the specified touch-related condition.

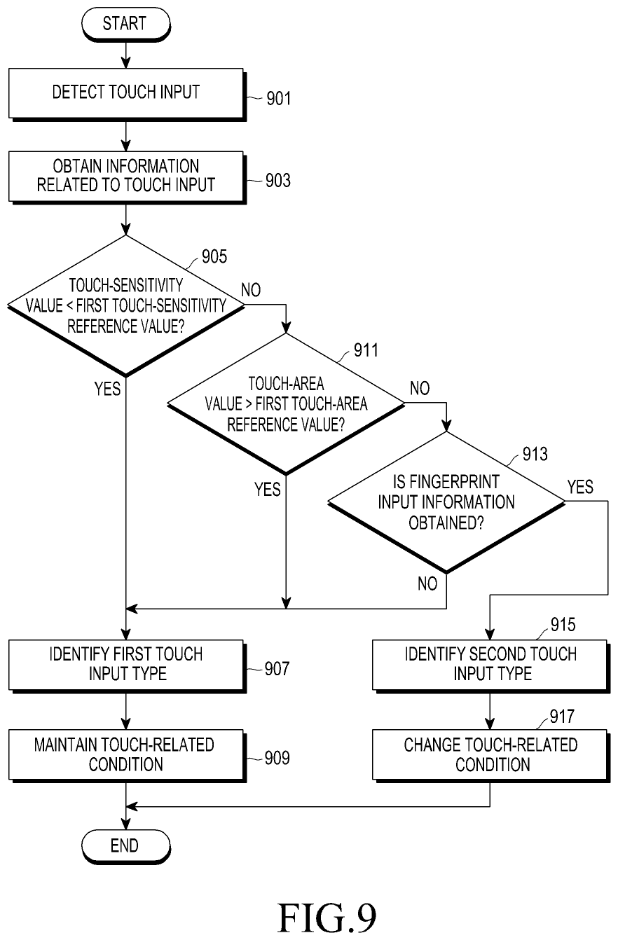

FIG. 9 is a flowchart illustrating an example operation of an electronic device according to various embodiments.

In operation 901, the electronic device may detect a touch input by at least one of a plurality of sensors included in the sensor module (e.g., the sensor module 276 in FIG. 2 or the sensor module 340 in FIG. 3).

As the electronic device detects the touch input, the electronic device may obtain a touch detection value from the at least one sensor, and may obtain information related to the touch input using the obtained touch detection value in operation 903. The information related to the touch input may include at least one of a touch-sensitivity value, a touch area, and fingerprint input information, which are obtained using the touch detection values.

In operation 905, the electronic device may compare the touch-sensitivity value included in the obtained information related to the touch input with a specified first touch-sensitivity reference value. As a result of the comparison, if the touch-sensitivity value is less than the first touch-sensitivity reference value, the electronic device may perform operation 907.

In operation 907, the electronic device may identify the touch input type for the touch input as a first touch input type (e.g., a touch by the glove or cover). In operation 909, the electronic device may maintain the touch-related condition specified for the first touch input type.

If the touch-sensitivity value is not less than the first touch-sensitivity reference value as a result of the comparison in operation 905, the electronic device may compare a touch-area value with a specified first touch-area reference value in operation 911. As a result of the comparison, if the touch-area value is greater than the first touch-area reference value, the electronic device may perform operation 907 and operation 909.

If the touch-area value is not greater than the first touch-area reference value as a result of the comparison in operation 911, the electronic device may confirm whether fingerprint input information has been obtained in operation 913. If it is confirmed that the fingerprint input information has not been obtained in operation 913, the electronic device may perform operation 907 and operation 909.

If it is confirmed that the fingerprint input information has been obtained in operation 913, the electronic device may identify the touch input type for the touch input as a second touch input type (e.g., a touch by the hand) in operation 915. In operation 917, the electronic device may change the specified touch-related condition into a touch input condition for easily identifying the touch input of the second touch input type. That is, the electronic device may switch from the first touch-related condition specified to correspond to the first touch input type to the second touch-related condition corresponding to the second touch input type.

According to various embodiments, the electronic device may, for example, perform only one of the comparison of the touch-sensitivity value in operation 905 or the comparison of the touch-area value in operation 911, among the operations in FIG. 9 described above, thereby confirming the fingerprint input information. In addition, the electronic device may perform the confirmation of the fingerprint input information in operation 913 prior to the confirmation of the touch-sensitivity value and the touch-area value (operation 905 or 911), among the operations in FIG. 9 described above.

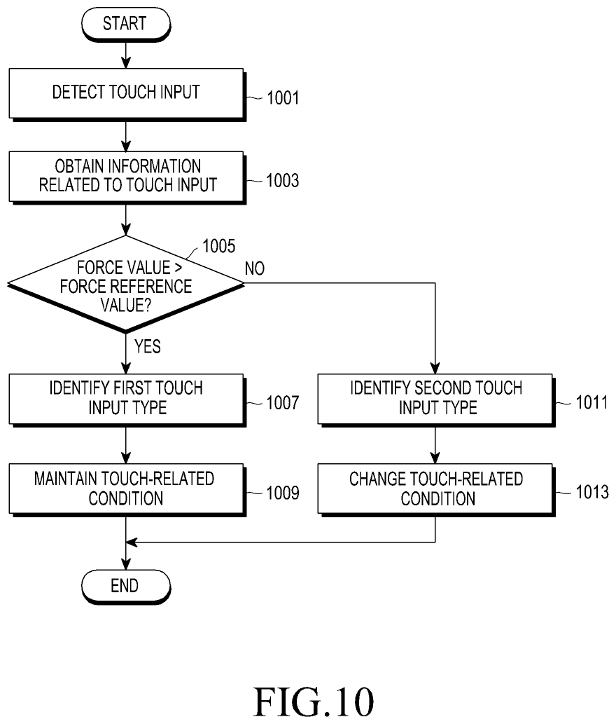

FIG. 10 is a flowchart illustrating an example operation of an electronic device according to various embodiments.

In operation 1001, when a touch input by the user occurs, the electronic device may detect the touch input using at least one (e.g., a fingerprint sensor) of a plurality of sensors included in the sensor module (e.g., the sensor module 276 in FIG. 2 or the sensor module 340 in FIG. 3).

As the electronic device detects the touch input, the electronic device may obtain a touch detection value from the at least one sensor, and may obtain information related to the touch input using the obtained touch detection value in operation 1003. The information related to the touch input may include a force value obtained using the touch detection value.

In operation 1005, the electronic device may compare the force value included in the information related to the touch input with a first force reference value included in a specified touch-related condition.

As a result of the comparison in operation 1005, if the force value is greater than the first force reference value, the electronic device may identify the touch input type for the touch input as a first touch input type in operation 1007. In operation 1009, the electronic device may maintain the touch-related condition specified for the first touch input type.

If the force value is not greater than the first force reference value as a result of the comparison in operation 1005, the electronic device may identify the touch input type for the touch input as a second touch input type (e.g., a touch by the hand) in operation 1011. In operation 1013, the electronic device may change the specified touch-related condition.

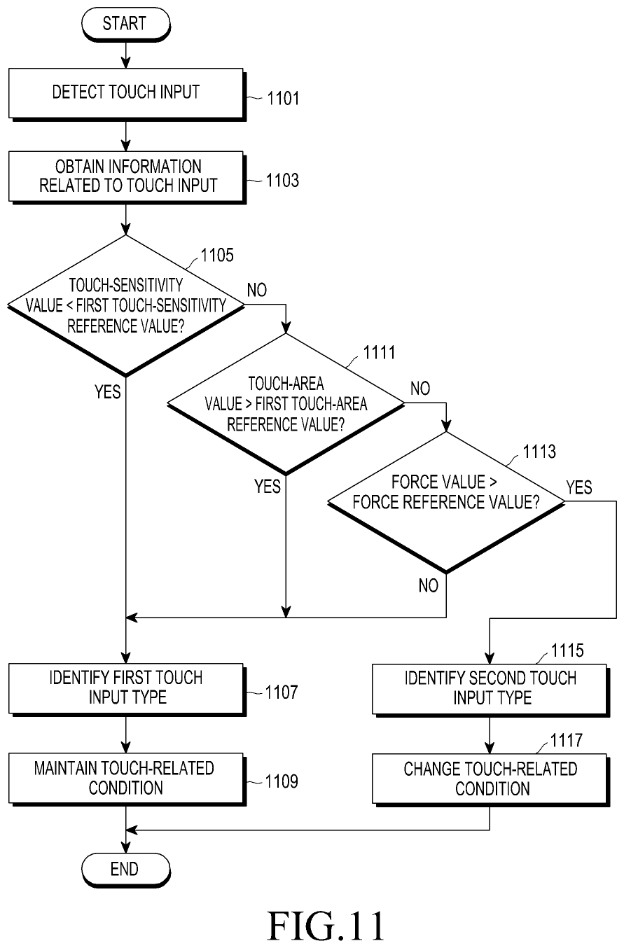

FIG. 11 is a flowchart illustrating an example operation of an electronic device according to various embodiments.

In operation 1101, the electronic device may detect a touch input by at least one of a plurality of sensors included in the sensor module (e.g., the sensor module 276 in FIG. 2 or the sensor module 340 in FIG. 3).

As the electronic device detects the touch input, the electronic device may obtain a touch detection value from the at least one sensor, and may obtain information related to the touch input using the obtained touch detection value in operation 1103. The information related to the touch input may include at least one of a touch-sensitivity value, a touch area, and a force value, which are obtained using the touch detection values.

In operation 1105, the electronic device may compare the touch-sensitivity value included in the obtained information related to the touch input with a specified first touch-sensitivity reference value. As a result of the comparison, if the touch-sensitivity value is less than the first touch-sensitivity reference value, the electronic device may perform operation 1107.

In operation 1107, the electronic device may identify the touch input type for the touch input as a first touch input type (e.g., a touch by the glove or cover). In operation 1109, the electronic device may maintain the touch-related condition specified for the first touch input type.

If the touch-sensitivity value is not less than the first touch-sensitivity reference value as a result of the comparison in operation 1105, the electronic device may compare the touch-area value with a specified first touch-area reference value in operation 1111. As a result of the comparison, if the touch-area value is greater than the first touch-area reference value, the electronic device may perform operation 1107 and operation 1109.

If the touch-area value is not greater than the first touch-area reference value as a result of the comparison in operation 1111, the electronic device may compare the force value with a specified force reference value in operation 1113.

As a result of the comparison in operation 1113, if the force value is not greater than the force reference value, the electronic device may perform operation 1107 and operation 1109.

If the force value is greater than the force reference value as a result of the comparison in operation 1113, the electronic device may identify the touch input type for the touch input as a second touch input type (e.g., a touch by the hand). In operation 1117, the electronic device may change the specified touch-related condition into a touch input condition for easily identifying a touch input of the second touch input type. That is, the electronic device may switch from the first touch-related condition specified to correspond to the first touch input type to the second touch-related condition corresponding to the second touch input type.

According to various embodiments, the electronic device may perform only one of the comparison of the touch-sensitivity value in operation 1105 or the comparison of the touch-area value in operation 1111, among the operations in FIG. 11 described above, thereby performing the comparison of the force value. In addition, the electronic device may perform the confirmation of the force value in operation 1113 prior to the confirmation of the touch-sensitivity value and the touch-area value (operation 1105 or 1111), among the operations in FIG. 11 described above.

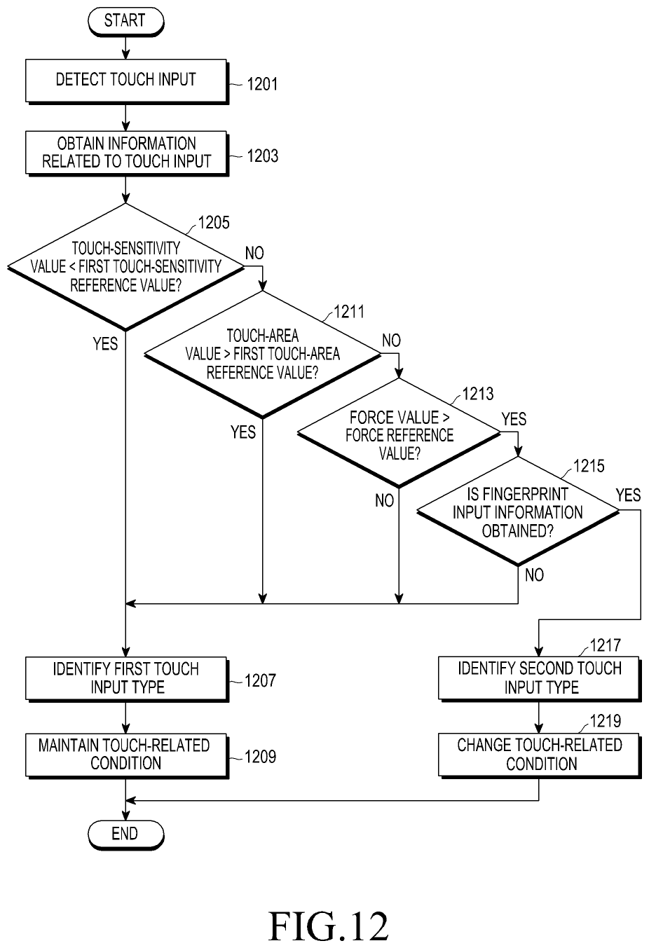

FIG. 12 is a flowchart illustrating an example operation of an electronic device according to various embodiments.

In operation 1201, the electronic device may detect a touch input by at least one of a plurality of sensors included in the sensor module (e.g., the sensor module 276 in FIG. 2 or the sensor module 340 in FIG. 3).

As the electronic device detects the touch input, the electronic device may obtain a touch detection value from the at least one sensor, and may obtain information related to the touch input using the obtained touch detection value in operation 1203. The information related to the touch input may include at least one of a touch-sensitivity value, a touch area, and a force value, which are obtained using the touch detection values.

In operation 1205, the electronic device may compare the touch-sensitivity value included in the obtained information related to the touch input with a specified first touch-sensitivity reference value. As a result of the comparison, if the touch-sensitivity value is less than the first touch-sensitivity reference value, the electronic device may perform operation 1207.

In operation 1207, the electronic device may identify the touch input type for the touch input as a first touch input type (e.g., a touch by the glove or cover). In operation 1209, the electronic device may maintain the touch-related condition specified for the first touch input type.

If the touch-sensitivity value is not less than the first touch-sensitivity reference value as a result of the comparison in operation 1205, the electronic device may compare the touch-area value with a specified first touch-area reference value in operation 1211. As a result of the comparison, if the touch-area value is greater than the first touch-area reference value, the electronic device may perform operation 1207 and operation 1209.

If the touch-area value is not greater than the first touch-area reference value as a result of the comparison in operation 1211, the electronic device may compare the force value with a specified force reference value in operation 1213.

As a result of the comparison in operation 1213, if the force value is not greater than the force reference value, the electronic device may perform operation 1207 and operation 1209.

If the force value is greater than the force reference value as a result of the comparison in operation 1213, the electronic device may confirm whether fingerprint input information has been obtained in operation 1215.

If it is confirmed that the fingerprint input information has not been obtained in operation 1215, the electronic device may perform operation 1207 and operation 1209.

If it is confirmed that the fingerprint input information has been obtained in operation 1215, the electronic device may identify the touch input type for the touch input as a second touch input type (e.g., a touch by the hand) in operation 1217. In operation 1219, the electronic device may change the specified touch-related condition into a touch input condition for easily identifying a touch input of the second touch input type. That is, the electronic device may switch from the first touch-related condition specified to correspond to the first touch input type to the second touch-related condition corresponding to the second touch input type.

According to various embodiments, the electronic device may perform only one of the comparison of the touch-sensitivity value in operation 1205 or the comparison of the touch-area value in operation 1211, among the operations in FIG. 12 described above, thereby performing the comparison of the force value and the confirmation of the fingerprint input information. In addition, the electronic device may perform operation 1213 or operation 1215 prior to the confirmation of the touch-sensitivity value or the touch-area value (operation 1205 or 1211), among the operations in FIG. 12 described above. The sequences of the operations of confirming the touch-sensitivity value, the touch-area value, the force value, and the fingerprint input information (e.g., operations 1205, 1211, 1213, and 1215) may vary with various combinations thereof.

In the operation procedure described above with reference to FIGS. 6, 7, 8, 9, 10, 11 and 12, the touch-related condition may be a condition related to the sensitivity indicating the ability for a response to a touch, and may include at least one of the touch sensitivity, the touch area, and the hover rejection. The touch-related condition may switch from the first touch-related condition specified to correspond to the first touch input type (e.g., a touch by the glove or cover) to the second touch-related condition specified to correspond to the second touch input type (e.g., a touch by the hand) in order to set a response to the touch differently depending on the touch input type. In addition, the touch-related condition may be set differently according to other touch input types.

For example, since the touch input by the glove or cover exhibits a small detection value, the first touch-related condition may include a first touch-sensitivity reference value, which is set so as to detect even a small detection value. For example, since the touch input by a glove or a cover can be detected only with a large touch area, the first touch-related condition may include a first touch-area reference value, which is set so as to detect even a large touch area. In addition, the first touch-related condition may include a first hover rejection condition, which is set to seldom allow the hover rejection for the first touch input type (e.g., a touch by the glove or cover).

For example, since the touch input by the hand exhibits a large detection value, the second touch-related condition may include a second touch-sensitivity reference value, which is set so as to reject a small touch detection value or a small touch-sensitivity value. The second touch-sensitivity reference value may have a sensitivity value or level greater than that of the first touch-sensitivity reference value. For example, since the touch input by the hand exhibits a large detection value, the touch input can be detected even with a small touch area. Therefore, the second touch-related condition may include a second touch-area reference value in which the touch area is set to be less than that of the first touch-area reference value. In addition, the second touch-related condition may include a second hover rejection condition, which is set so as to easily allow the hover rejection for the second touch input type (e.g., a touch by the hand).

An operating method according to any one of various embodiments may include receiving information related to a touch input by a touch circuit and/or by at least one of a plurality of sensors of an electronic device, identifying the touch input type for the touch input based on the information related to the touch input, and determining a touch-related condition related to the touch circuit based on the identified touch input type.

According to various embodiments, the determining of a touch-related condition related to the touch circuit based on the identified touch input type may include maintaining the touch-related condition if the touch input is identified as a first touch input type, and if the touch input is identified as a second touch input type, changing the touch-related condition into a touch-related condition corresponding to the second touch input type.

According to various embodiments, the identifying of the touch input type for the touch input may include identifying a first touch input type for the touch input if a touch-sensitivity value included in the information related to the touch input is less than a specified touch-sensitivity reference value and/or if a touch-area value included in the information related to the touch input is greater than a specified touch-area reference value, and identifying a second touch input type for the touch input if a touch-sensitivity value included in the information related to the touch input is not less than a specified touch-sensitivity reference value and/or if a touch-area value included in the information related to the touch input is not greater than a specified touch-area reference value.

According to various embodiments, the identifying of the touch input type for the touch input may include identifying a first touch input type for the touch input if fingerprint input information included in the information related to the touch input is not confirmed, and identifying a second touch input type for the touch input if fingerprint input information included in the information related to the touch input is confirmed.

According to various embodiments, the identifying of the touch input type for the touch input may include identifying a first touch input type for the touch input if a force value included in the information related to the touch input is not greater than a specified force reference value, and identifying a second touch input type for the touch input if a force value included in the information related to the touch input is greater than a specified force reference value.

According to various embodiments, the identifying of the touch input type for the touch input may include identifying a first touch input type for the touch input if fingerprint input information included in the information related to the touch input is not confirmed and if a force value included in the information related to the touch input is not greater than a specified force reference value, and identifying a second touch input type for the touch input if fingerprint input information included in the information related to the touch input is confirmed and if a force value included in the information related to the touch input is greater than a specified force reference value.

An operating method according to any one of various embodiments may include obtaining a touch detection value for a touch input detected through a touch circuit, obtaining at least one of a touch-sensitivity value and/or a touch-area value for the touch input using the touch detection value, identifying the touch input type for the touch input based on at least one of the obtained touch-sensitivity value or the obtained touch-area value, and determining a touch-related condition related to the touch circuit based on the identified touch input type.

An electronic device according to various embodiments disclosed herein may be various types of devices. The electronic device may, for example, and without limitation, include at least one of a portable communication device (e.g., smartphone) a computer device, a portable multimedia device, a portable medical device, a camera, a wearable device, a home appliance, or the like. The electronic device according to embodiments of the disclosure is not limited to the above-described devices.

Various embodiments provide a non-transitory computer-readable recording medium having recorded thereon a program, which when executed in a computer or by a processor, cause an electronic device to perform operations comprising: receiving information related to a touch input, which is obtained by a touch circuit and/or by at least one of a plurality of sensors of an electronic device; identifying the touch input type for the touch input based on the information related to the touch input; and determining a touch-related condition related to the touch circuit based on the identified touch input type.

Various embodiments provide a non-transitory computer-readable recording medium having recorded thereon a program, which when executed in a computer or by a processor, cause an electronic device to perform operations comprising: obtaining a touch detection value for a touch input detected through a touch circuit; obtaining at least one of a touch-sensitivity value and/or a touch-area value for the touch input using the touch detection value; identifying the touch input type for the touch input based on at least one of the obtained touch-sensitivity value or the obtained touch-area value; and determining a touch-related condition related to the touch circuit based on the identified touch input type.

Various embodiments disclosed herein are merely illustrative and provided aid in understanding of the disclosure, and are not intended to limit the scope of the disclosure. Accordingly, the scope of the disclosure should be understood as including all modifications or various other embodiments based on the technical idea of the disclosure.

What is claimed is:

1. An electronic device comprising:
a sensor module comprising a plurality of sensors;
a touch circuit;
a processor electrically connected to the sensor module and the touch circuit; and
a memory electrically connected to the processor, wherein the memory includes instructions that, when executed by the processor, control the electronic device to:
receive information related to a touch input obtained by the touch circuit and/or by at least one of the plurality of sensors;
identify a touch input type for the touch input based on the information related to the touch input; and
determine a touch-related condition related to the touch circuit based on the identified touch input type.

2. The electronic device of claim 1, wherein the information related to the touch input is obtained using a touch detection value for the touch input,
wherein the information related to the touch input comprises at least one of: a touch-sensitivity value, a touch-area value, a force value, and/or fingerprint input information, and
wherein the touch-related condition comprises at least one of: a touch sensitivity condition, a touch area condition, and/or a hover rejection condition.

3. The electronic device of claim 1, wherein the instructions, when executed by the processor, control the electronic device to:
identify a first touch input type for the touch input if a touch-sensitivity value included in the information related to the touch input is less than a specified touch-sensitivity reference value and/or if a touch-area value included in the information related to the touch input is greater than a specified touch-area reference value; and
maintain the touch-related condition corresponding to the identified first touch input type.

4. The electronic device of claim 1, wherein the instructions, when executed by the processor, control the electronic device to:
identify a second touch input type for the touch input if a touch-sensitivity value included in the information related to the touch input is not less than a specified touch-sensitivity reference value and/or if a touch-area value included in the information related to the touch input is not greater than a specified touch-area reference value; and
change the touch-related condition to a touch-related condition corresponding to the identified second touch input type.

5. The electronic device of claim 1, wherein the instructions, when executed by the processor, control the electronic device to:
identify a first touch input type for the touch input if fingerprint input information included in the information related to the touch input is not confirmed and maintain the touch-related condition corresponding to the identified first touch input type; and
identify a second touch input type for the touch input if fingerprint input information included in the information related to the touch input is confirmed and change the touch-related condition to a touch-related condition corresponding to the identified second touch input type.

6. The electronic device of claim 1, wherein the processor is configured to control the electronic device to:
identify a first touch input type for the touch input if a force value included in the information related to the touch input is not greater than a specified force reference value and maintain the touch-related condition corresponding to the identified first touch input type; and
identify a second touch input type for the touch input if a force value included in the information related to the touch input is greater than a specified force reference value and change the touch-related condition to a touch-related condition corresponding to the identified second touch input type.

7. The electronic device of claim 1, wherein the instructions, when executed by the processor, control the electronic device to:
identify a first touch input type for the touch input if fingerprint input information included in the information related to the touch input is not confirmed and if a force value included in the information related to the touch input is not greater than a specified force reference value and maintain the touch-related condition corresponding to the identified first touch input type; and
identify a second touch input type for the touch input if fingerprint input information included in the information related to the touch input is confirmed and if a force value included in the information related to the touch input is greater than a predetermined force reference value and change the touch-related condition to a touch-related condition corresponding to the identified second touch input type.

8. The electronic device of claim 1, wherein the instructions, when executed by the processor, control the electronic device to:
identify a second touch input type for the touch input if the touch-sensitivity value and the touch-area value included in the information related to the touch input are not confirmed and if fingerprint input information is confirmed; and
change the touch-related condition to a touch-related condition corresponding to the identified second touch input type.

9. The electronic device of claim 1, wherein a changed touch-related condition comprises at least one of: a second touch-sensitivity reference value set to be greater than the specified first touch-sensitivity reference value, a second touch-area reference value set to be less than the specified first touch-area reference value, and/or a hover reject condition in which the hover rejection rate is set to be high.

10. An electronic device comprising:
a touch circuit;
a processor electrically connected to the touch circuit; and
a memory electrically connected to the processor, wherein the memory comprises instructions that, when executed by the processor, control the electronic device to:
obtain a touch detection value for a touch input detected through the touch circuit;
obtain at least one of: a touch-sensitivity value and/or a touch-area value for the touch input using the touch detection value;
identify a touch input type for the touch input based on at least one of the obtained touch-sensitivity value and/or the obtained touch-area value; and
determine a touch-related condition related to the touch circuit based on the identified touch input type.

11. The electronic device of claim 10, wherein the instructions, when executed by the processor, control the electronic device to:
identify a first touch input type for the touch input if a touch-sensitivity value included in the information related to the touch input is less than a specified touch-sensitivity reference value and/or if a touch-area value included in the information related to the touch input is greater than a specified touch-area reference value; and
maintain the touch-related condition corresponding to the identified first touch input type.

12. The electronic device of claim 10, wherein the instructions, when executed by the processor, control the electronic device to:
identify a second touch input type for the touch input if a touch-sensitivity value included in the information related to the touch input is not less than a specified touch-sensitivity reference value and/or if a touch-area value included in the information related to the touch input is not greater than a specified touch-area reference value; and
change the touch-related condition to a touch-related condition corresponding to the identified second touch input type.

13. The electronic device of claim 10, wherein the instructions, when executed by the processor, control the electronic device to:
confirm at least one of fingerprint input information and/or a force value if the touch-sensitivity value and the touch-area value are not confirmed;
identify a second touch input type for the touch input if the fingerprint input information is obtained and/or if it is confirmed that the force value is greater than a specified force reference value; and
change the touch-related condition to a touch-related condition corresponding to the identified second touch input type.

14. A non-transitory computer-readable recording medium having recorded thereon a program which, when executed by a processor, cause an electronic device to perform operations comprising:
receiving information related to a touch input obtained by a touch circuit and/or by at least one of a plurality of sensors of an electronic device;
identifying the touch input type for the touch input based on the information related to the touch input; and
determining a touch-related condition related to the touch circuit based on the identified touch input type.

15. The non-transitory computer-readable recording medium of claim 14, wherein the determining of a touch-related condition related to the touch circuit based on the identified touch input type comprises:
maintaining the touch-related condition if the touch input is identified as a first touch input type; and
if the touch input is identified as a second touch input type, changing the touch-related condition to a touch-related condition corresponding to the second touch input type.

16. The non-transitory computer-readable recording medium of claim 14, wherein the identifying of the touch input type for the touch input comprises:
identifying a first touch input type for the touch input if a touch-sensitivity value included in the information related to the touch input is less than a specified touch-sensitivity reference value and/or if a touch-area value included in the information related to the touch input is greater than a specified touch-area reference value; and
identifying a second touch input type for the touch input if a touch-sensitivity value included in the information related to the touch input is not less than a specified touch-sensitivity reference value and/or if a touch-area value included in the information related to the touch input is not greater than a specified touch-area reference value.

17. The non-transitory computer-readable recording medium of claim 14, wherein the identifying of the touch input type for the touch input comprises:
identifying a first touch input type for the touch input if fingerprint input information included in the information related to the touch input is not confirmed; and
identifying a second touch input type for the touch input if fingerprint input information included in the information related to the touch input is confirmed.

18. The non-transitory computer-readable recording medium of claim 14, wherein the identifying of the touch input type for the touch input comprises:
identifying a first touch input type for the touch input if a force value included in the information related to the touch input is not greater than a specified force reference value; and
identifying a second touch input type for the touch input if a force value included in the information related to the touch input is greater than a specified force reference value.

19. The non-transitory computer-readable recording medium of claim 14, wherein the identifying of the touch input type for the touch input comprises:
identifying a first touch input type for the touch input if fingerprint input information included in the information related to the touch input is not confirmed and if a force value included in the information related to the touch input is not greater than a specified force reference value; and
identifying a second touch input type for the touch input if fingerprint input information included in the information related to the touch input is confirmed and if a force value included in the information related to the touch input is greater than a specified force reference value.

20. A non-transitory computer-readable recording medium having recorded thereon a program which, when executed by a processor, causes an electronic device to perform operations comprising:
obtaining a touch detection value for a touch input detected through a touch circuit;
obtaining at least one of a touch-sensitivity value and/or a touch-area value for the touch input using the touch detection value;
identifying the touch input type for the touch input based on at least one of the obtained touch-sensitivity value and/or the obtained touch-area value; and
determining a touch-related condition related to the touch circuit based on the identified touch input type.
